(19) United States
(12) Patent Application Publication
(10) Pub. No.: US 2023/0046686 A1
(43) Pub. Date: Feb. 16, 2023

(54) Method for Frictionless Shopping Based on Shopper Habits and Preferences

(71) Applicant: Toshiba Global Commerce Solutions Holdings Corporation, Tokyo (JP)

(72) Inventors: Brad M. Johnson, Raleigh, NC (US); Adrian Rodriguez, Durham, NC (US); John Pistone, Cary, NC (US)

(21) Appl. No.: 17/393,706

(22) Filed: Aug. 4, 2021

(51) Int. Cl. G06Q 30/02; G06T 7/90

(52) U.S. Cl. CPC G06Q 30/0282; G06Q 30/0281; G06Q 30/0278; G06T 7/90

(57) ABSTRACT

A computing device provides shoppers with a frictionless commerce experience. The computing device determines, tracks, and stores certain physical characteristics and/or attributes of the products selected by a shopper for purchase. The device analyzes these attributes with respect to the shopper's particular purchasing habits and uses the results of that analysis to recommend products to the shopper. Additionally, the computing device may modify the sales price of the product, or augment the shopper's order with the same or similar products, based on the results of the analysis.

### TECHNICAL FIELD

The present disclosure relates to systems and methods for providing a frictionless commerce experience to customers.

### BACKGROUND

Frictionless commerce is currently a popular trend permeating many facets of today's customer shopping experience. In general, frictionless commerce leverages technology to improve a customer's retail experience and to increase sales by recommending certain products for purchase to the customer. To accomplish its goal, frictionless commerce uses data stored on the customer's devices (e.g., Smartphones), as well as software applications executing on those devices and/or on websites, to seamlessly integrate purchasing activities and purchasing opportunities into the customer's shopping experience.

### BRIEF DESCRIPTION OF THE DRAWINGS

FIG. 1 is a functional block diagram illustrating a system configured to provide customers with a frictionless commerce experience according to one embodiment of the present disclosure.

FIG. 2 is a flow chart illustrating a method for determining customer preferences for a frictionless commerce experience according to one embodiment of the present disclosure.

FIG. 3 is a flow chart illustrating a method for providing customers with a frictionless commerce experience according to one embodiment of the present disclosure.

FIG. 4A is a flow chart illustrating a method for determining the ripeness of a product according to one embodiment of the present disclosure.

FIG. 4B is a flow chart illustrating a method for determining the freshness of a product according to one embodiment of the present disclosure.

FIG. 5 is a schematic block diagram illustrating some of the component parts of a computing device configured to provide customers with a frictionless commerce experience according to one embodiment of the present disclosure.

FIG. 6 is a functional block diagram illustrating a computer program product configured to control a computer to provide customers with a frictionless commerce experience according to one embodiment of the present disclosure.

### DETAILED DESCRIPTION

Embodiments of the present disclosure provide shoppers with a frictionless commerce experience. More particularly, a computer system configured according to the present embodiments determines, tracks, and stores certain physical characteristics and/or attributes of the products selected by a shopper for purchase. The system then analyzes these attributes with respect to the shopper's particular purchasing habits and uses the results of that analysis to make product recommendations to the shopper. The recommendations may be for the same preferred product or, if that product is out-of-stock, for a similar product.

As an example, consider situations where a shopper purchases produce at a retail store. Over time, a system configured according to the present embodiments captures information associated with the physical attributes of the selected produce, such as the ripeness and/or freshness of the produce. As described in more detail later, such information may be captured, for example, using cameras positioned throughout the retail store and/or provided by the shopper. The system can then analyze the captured information to determine whether the shopper prefers to purchase particular produce at a particular stage of ripeness and/or freshness. If so, the system can send messages to the shopper's mobile device recommending that the shopper purchase produce at the determined stage of ripeness and/or freshness during the shopper's subsequent visits.

As defined herein, a “shopper” is an entity that selects products and/or services offered by a retail establishment for purchase by the general public. For example, a shopper may be a customer of the retail establishment. Additionally, or alternatively, a shopper may be a “picker” (i.e., an employee of the retail establishment whose job it is to select the products and/or services for purchase by a customer of the retail establishment). In these latter cases, the recommendation messages provided to a device of a picker are generated based on the preferences of the customer for which he/she is shopping. Thus, when the picker is selecting produce for a given customer, the system would send messages to the picker's device recommending that the picker select produce at the given customer's preferred stage of ripeness and/or freshness.

Regardless of the particular products, services, or whether the shopper is a customer or a picker, however, a system configured according to the present embodiments provides customized purchase recommendations to the shopper based on information that is repeatedly updated and analyzed over time. This allows the system to remain “up-to-date” with respect to a given customer's changing preferences and to provide recommendations that are most appropriate for a shopper.

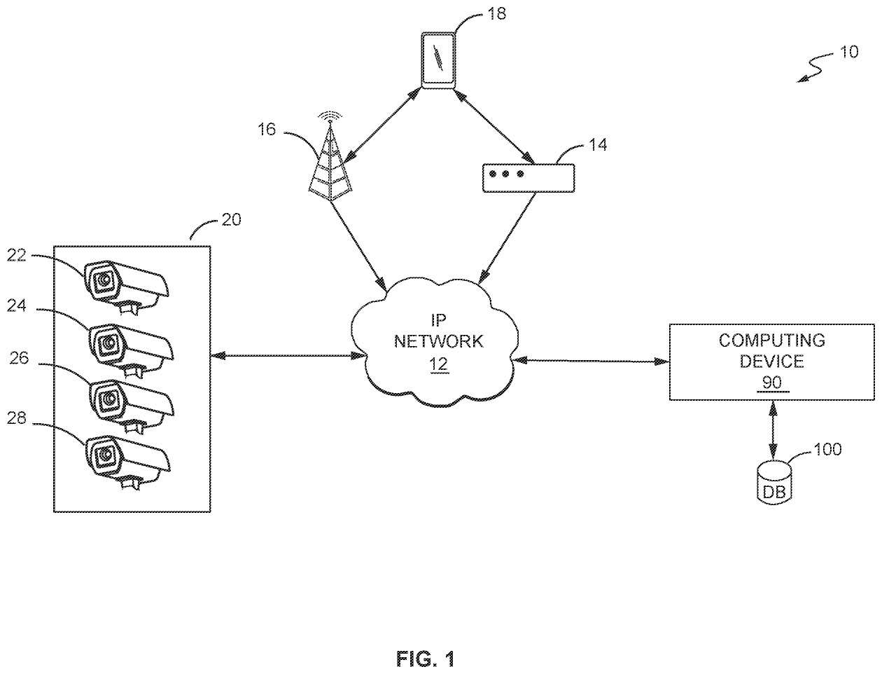

Turning now to the drawings, FIG. 1 is a functional block diagram illustrating some components of a system 10 configured according to an embodiment of the present disclosure. According to the present disclosure, system 10 may be configured for, and used in, a wide variety of environments. However, solely for illustrative purposes, system 10 is described herein in accordance with its configuration in a retail establishment environment. Regardless of its particular environment, however, system 10 may be a “local” system, in which most or all the components seen in FIG. 1 are associated with (and perhaps co-located with) a single retail establishment (e.g., so-called “mom-n-pop” shops), or a “non-local” system, in which one or more of the components are remote from each other and distributed over a wider geographical area. Retail establishments that may be suited for such “non-local” systems 10 include, but are not limited to, nation-wide store chains such as BEST BUY, HARRIS TEETER, COSTCO, and the like.

As seen in FIG. 1, system 10 comprises a communication network 12 communicatively connecting a plurality of video cameras 22, 24, 26, 28 (collectively herein, “cameras 20”) to a computing device 90 and a database (DB) 100. Additionally, network 12 communicatively connects to a shopper's wireless device 18 (e.g., a SMARTPHONE or tablet computing device). Such connections include, but are not limited to, wireless routers 14 located at the retail establishment and wireless communications networks having one or more base stations 16. Wireless routers, wireless communications networks, and the manner in which they communicatively interface wireless devices 18 with retail networks, such as network 12, are well known in the art, and thus, not described in detail here. However, it is enough to understand that network 12, which may be one or more private and/or public IP networks (e.g., the Internet and/or a Local Area Network (LAN) and/or a Wide Area Networks (WAN)) provides shoppers with access to the various e-commerce systems associated with the retail establishment.

In this embodiment, cameras 20 comprises a plurality of cameras configured to capture images of the products a shopper selects for purchase. As is known in the art, cameras 20 may be distributed throughout the store and be positioned to capture images at different angles. The images may be utilized to identify the particular products selected for purchase by a shopper, but also to identify the shopper using known facial recognition techniques. Thus, one or more of the cameras 22, 24, 26, 28 may be positioned at the entrance/exit of the retail establishment, and/or along the aisles of the retail establishment, and/or at the checkout stations of the retail establishment. Regardless of their positioning, however, the images captured by the cameras 20 are communicated to computing device 90 for image processing, analysis, and storage in DB 100.

Computing device 90 may be any computing device known in the art and, as described in more detail below, comprises processing circuitry and software instructions configured to implement embodiments of the present disclosure. By way of example only, computing device 90 may be an application server (AS) configured to operate according to the present disclosure. Regardless of its particular structure, however, computing device 90 is configured according to the present embodiments to obtain digital images of a product selected for purchase by a shopper, perform a digital image analysis on those digital images, and then determine a state of the product based on the analysis. Based on the results of that analysis and on one or more predefined preferences regarding a customer's preferred state of a product, computing device 90 is configured to generate feedback information for transmission to the shopper in one or more messages. As stated above, these messages include information recommending a product having the same or similar state as that preferred by the customer.

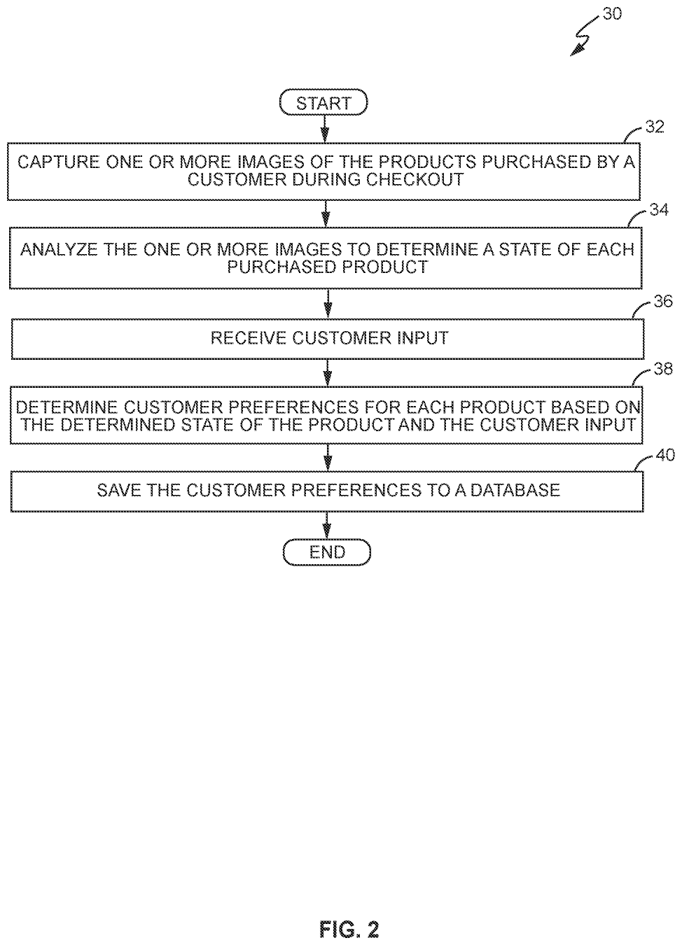

FIG. 2 is a flow chart illustrating a method 30 for determining customer preferences for a frictionless commerce experience according to one embodiment of the present disclosure. As seen in FIG. 2, cameras 20 positioned at a checkout station first capture one or more digital images of the products selected for purchase by a customer during a checkout process (box 32). The captured images are then provided to computing device 90, which may be co-located at the retail store or located remotely from the retail store. Once the images are received, computing device 90 performs a digital image analysis on the received images, and as descried in more detail below, determines a state of each purchased product (box 34). The state may indicate, for example, the particular ripeness or freshness of product being purchased. Additionally, while not specifically required, computing device 90 may receive input from the customer regarding the physical attributes of the product being purchased (box 36). For example, the customer may explicitly indicate the desired physical attributes and/or characteristics of the products being purchased. Based on the state of the product, computing device 90 then determines the customer preferences for the product (box 38) and stores those determined preferences to DB 100 (box 40).

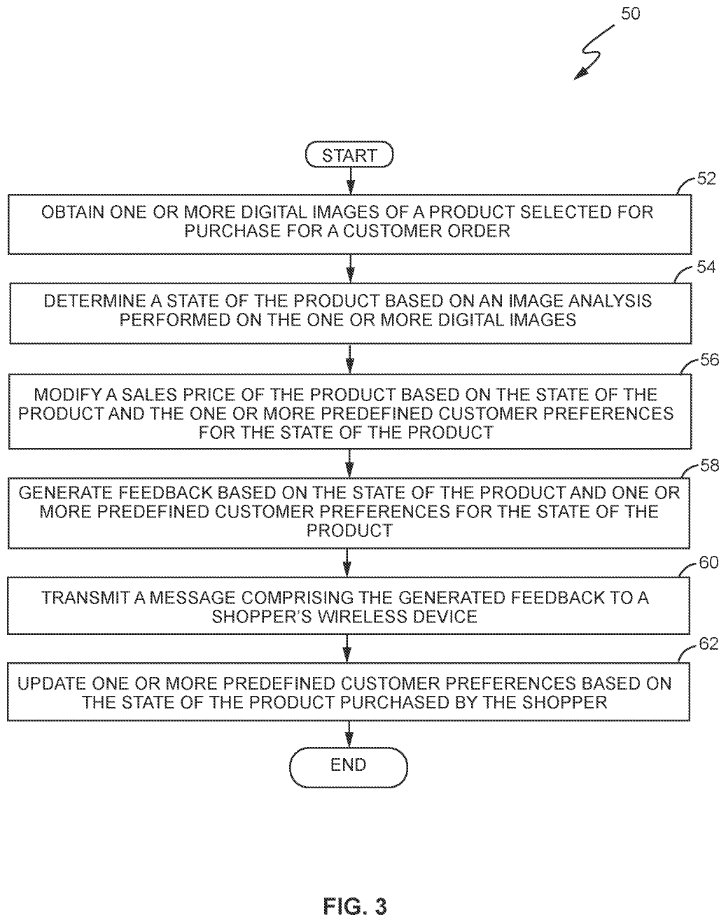

FIG. 3 is a flow chart illustrating a method 50 for providing a shopper with a frictionless commerce experience according to one embodiment of the present disclosure. As stated above, the shopper may be a customer of the retail establishment, or a “picker” tasked with selecting customer-identified products from the retail establishment for purchase by the customer.

Method 50 is implemented, in one embodiment, by computing device 90 and begins with obtaining one or more digital images of a product selected by a shopper for purchase for a customer order (box 52). The images may be captured by one or more of the cameras 20 at one or more different angles throughout the retail establishment. A state of the product is then determined based on a digital analysis performed on the captured images (box 54). For example, the analysis may identify a coloring or shade of a particular piece of produce, such as the green color of a banana peel, and based on that information, determine that the banana is not yet ripe. In another example, the analysis may identify a “best if used by” or “expiration” date on a label of a product. Based on that date information, the analysis may determine that the product is no longer fresh.

Regardless, in one embodiment, the results of the analysis may cause computing device 90 to modify the sales price of the product (box 56). Such is beneficial for a variety of reasons. Specifically, products that are determined to be in a particular state can be “marked-down” in price making them more appealing to the customer for purchase. Of course, the opposite is also true. That is, products determined to be in a particular state can be “marked-up” in price, or at least not discounted, based on the knowledge that the customer selecting these products actually prefers them to be in the determined state.

However, regardless of whether the price of the product is marked-up, discounted, or left alone, method 50 configures computing device 90 to generate feedback information based on the state of the product and on one or more of the customer preferences for the state of the product (box 58), and transmitted in a message to the customer's device (box 60). The feedback information may, as described previously, recommend that the customer purchase a particular product at the stage of ripeness and/or freshness deemed desirable to the customer. Method 50 then updates the predefined customer preferences based on the determined state of the selected product (box 62). As previously described, customer preferences may change over time; however, the present embodiments track those changing preferences thereby allowing system 10 to maintain a current database of customer preference information.

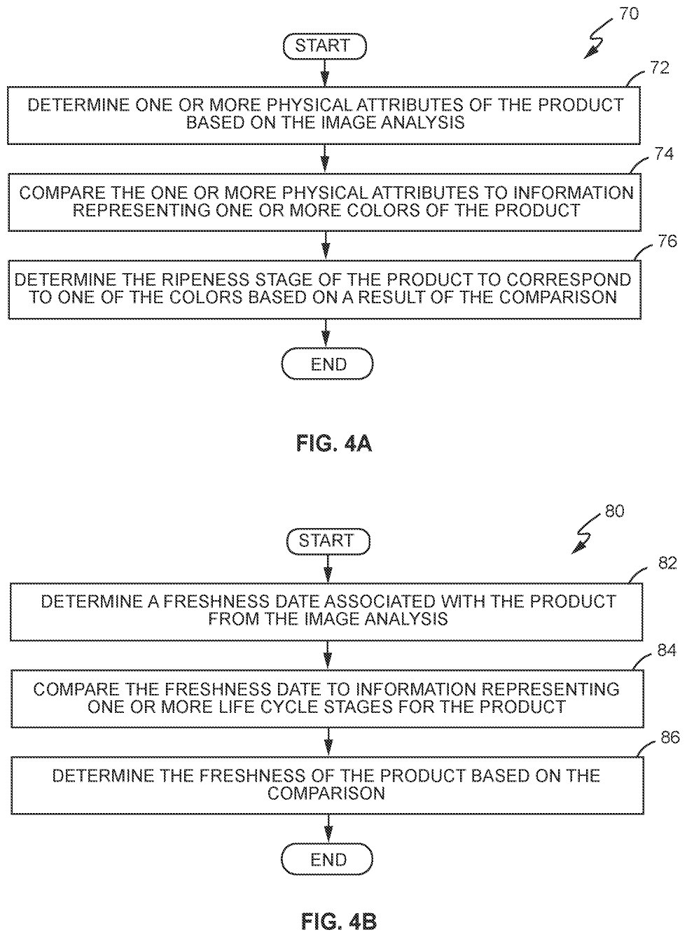

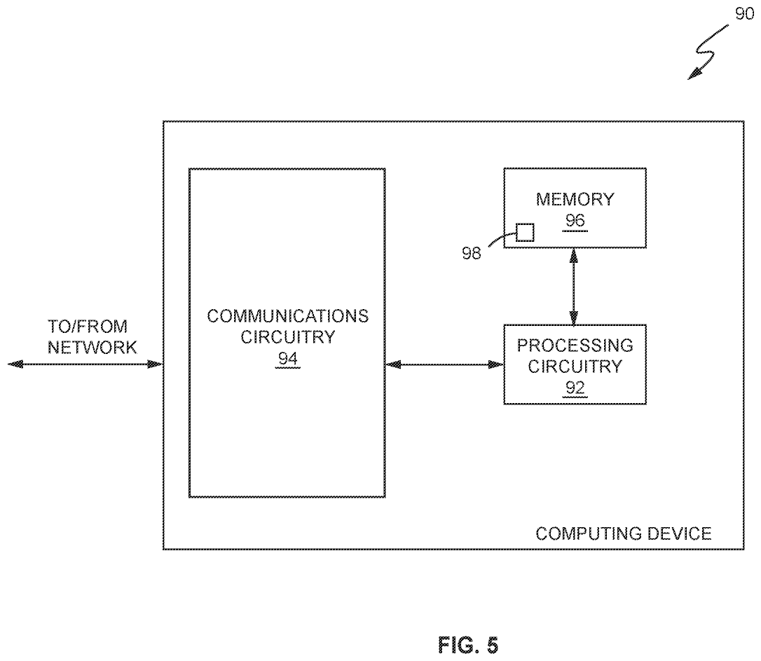

As stated above, computing device 90 is configured to determine various characteristics and/or attributes of a product based on the digital image analysis performed on the captured digital images. FIG. 4A, for example, is a flow chart illustrating a method 70 for determining the ripeness of a product according to one embodiment of the present disclosure. It is assumed in FIG. 4A that digital images of the product are already captured and obtained by computing device 90 for analysis.

As seen in FIG. 4A, method 70 begins with computing device 90 determining one or more physical attributes of a product selected by a customer based on a digital analysis performed on the product (box 72). The analysis may, for example, identify the current color of a piece of produce which a decision determining the ripeness of the produce can be based.

Any method known in the art may be utilized to optically identify the color of a piece of produce. For example, in one embodiment, an operator, such as a retail store employee, defines one or more stages of ripeness for each piece of produce offered for sale by the retail establishment. The number of stages, in one embodiment, is arbitrary. The operator then associates each stage with a particular color. According to the present embodiments, computing device 90 determines the color of the produce based on the results of the digital image analysis and compares that color to the colors associated with the different pre-defined stages of ripeness. Based on the results of that color comparison, computing device 90 can identify the particular stage of ripeness for the product.

In one embodiment, a table structure, such as shown below in Table 1, is stored in memory mapping the different ripeness stages to a corresponding color or shade of color. For illustrative purposes, the different colors are indicated using corresponding indicative labels “A,” “A/B,” . . . etc.

TABLE 1
Mapping Ripeness Stages to Colors

| RIPENESS STAGE | COLOR |
|---|---|
| 1 | A |
| 2 | A/B |
| . . . | . . . |
| 7 | E |

In another embodiment, the operator associates a plurality of ripeness stages for each piece of produce to a spectral reflectance or transmittance value for the product. In these embodiments, computing device 90 utilizes known techniques to estimate the spectral reflectance or transmittance value for the produce based on digitally processing the captured images. Once a value indicating the reflectance/transmittance is determined (which in this embodiment is defined as a percentage), computing device 90 compares that value to the pre-defined values provisioned by the operator and identifies the ripeness stage of produce based on the results of that comparison. In a variant of this embodiment, the resultant value can be translated or mapped to a corresponding color, which is then used to determine the corresponding ripeness stage. Table 2 below illustrates the type of information that can be stored in a table according to one embodiment.

TABLE 2
Mapping Ripeness Stages to Reflectance/Transmittance

| RIPENESS | % |
|---|---|
| STAGE | REFLECTANCE/TRANSMITTANCE |
| 1 | 10 |
| 2 | 25 |
| . . . | . . . |
| 7 | 95 |

In addition to, or in lieu of a ripeness stage, computing device 90 is also configured to determine the various characteristics and/or attributes of a product based the “freshness” of the product. FIG. 4B, for example, is a flow chart illustrating a method 80 for determining the freshness of a product (i.e., where the product is in its life cycle stage) according to one embodiment of the present disclosure. As above, it is assumed in FIG. 4B that digital images of the product have already been captured and obtained by computing device 90 for analysis.

In the embodiment of FIG. 4B, the digital images of the product would include the product label. In such cases, computing device 90 uses known techniques to optically identify the expiration or “use by” date printed on the label (box 82) and compares that date to the current date to obtain a scalar value representing the number of days that separate the two dates. Then, computing device compares the resultant scalar value to the information representing the life cycle stages for the product (box 84). Based on the comparison, computing device 90 determines the product's current life cycle stage thereby determining its freshness (box 86). Table 3 below illustrates the type of information that can be stored and used to determine the product freshness according to this embodiment.

TABLE 3
Mapping Freshness to Date Information

| LIFE CYCLE | |
|---|---|
| STAGE | DATE DIFFERENTIAL |
| 1 | −7 |
| 2 | −5 |
| . . . | . . . |
| 7 | +2 |

As seen in Table 3, each Life Cycle Stage is associated with a scalar “Date Differential” value. As stated above, these values indicate the number of days separating the expiration or use-by date on the product label from the current date. For example, a “−7” would indicate that the date printed on the label is still 7 days away from the date corresponding to that of the 1^{st} life cycle stage, and therefore, considered very fresh. Similarly, a “−5” would indicate that the current date is still 5 days away from the date corresponding to that of the 2nd subsequent life cycle stage, but still considered fresh. A “+2” would indicate that the current date is 2 days beyond the determined expiration or use-by date, and therefore, considered to be not fresh. Regardless of the particular values used, however, the information in Table 3 is used by computing device 90 to identify the how fresh the product selected by a shopper is.

Those of ordinary skill in the art should appreciate that the present embodiments also configure computing device 90 to identify label information other than an expiration date or use-by date. Such other information includes, but is not limited to, the Stock Keeping Unit (SKU) printed on a label. Based on the SKU, computing device 90 can determine, using information stored in DB 100, for example, when the particular product was placed on a shelf or display area for purchase, the lot number associated with the product, the expiration date, the use-by date, and/or other data by which computing device 90 can determine the ripeness and/or freshness of the product.

Determining the ripeness and/or freshness of a product, and tracking the personal shopping/selection habits of customers according to the present embodiments in general, provides benefits to both consumers and the owners of the retail establishments that conventional systems do not provide. For example, a system 10 configured according to the present embodiments incentivizes consumers to purchase certain recommended products. This is because the products recommended by computing device 90 have the same or similar physical characteristics and/or attributes as those previously purchased by the consumer. Therefore, the shopper is more inclined to purchase the recommended products.

Further, determining the ripeness and/or freshness of a product allows the owners of the retail establishments to dynamically adjust the prices for certain products. For example, products that have a limited shelf life (e.g., dairy products, vegetables, fruit, etc.) and that are at a later ripeness stage or life cycle stage could be offered at a larger discount to a shopper. Not only does the lower price incentivize the shopper to purchase produce having a shorter shelf life but it also reduces food waste. Selling more product while simultaneously reducing waste, in turn, results in a higher volume of sales and increased income for the retail establishment.

Additionally, with conventional methods of frictionless shopping, a picker will arbitrarily select a similar replacement product whenever the customer's desired product is out of stock in which case, the customer may end up paying for a replacement product that he/she does not want. Alternatively, the picker will contact the customer requesting them to identify a satisfactory replacement product. In these latter cases, the customer's frictionless shopping experience is hindered by the messages from the picker. With a computing device 90 configured according to the present embodiments, however, the customer preferences are readily available allowing the picker to select a desired product, or a replacement product, more accurately.

Those of ordinary skill in the art should readily appreciate that the present embodiments are not limited solely to determining and utilizing the measured freshness and/or ripeness of a product. Rather, other embodiments of the present disclosure glean and utilize other information from the digital analysis of the captured images. For example, in one embodiment, computing device 90 is configured to determine the number of products on a shelf or display area whenever a shopper selects that product. Based on this number, computing device 90 can determine whether the selected product was only recently placed on the shelf or display area, indicating that it is “fresh,” or whether it has been on the shelf or display area for some period of time.

In another embodiment, cameras 20 can capture images showing the position of the product on a shelf or display area. In these cases, computing device 90 may determine that products positioned farther back on a shelf or display area are “older” than those positioned closer to the front of the shelf or display area. Alternatively, computing device 90 may determine that products positioned more towards the front of the are “older” than those positioned closer to the back of the shelf or display area. Regardless, computing device 90 can dynamically modify the price of the product based on the determination, as described above, and send the modified price to the shopper's device in a transmitted message thereby incentivizing the shopper to purchase the product and allowing the retail establishment owner to “move” its merchandise and reduce waste.

In another embodiment, retail establishments label their products with temperature-sensitive labels. As is known in the art, such labels change color based on the temperature of the product. In these embodiments, at least one of the cameras 20 would capture the temperature indication of the label. So long as the temperature of the product (e.g., meat, dairy, etc.) remains within a predetermined temperature range, the color of the label remains constant. However, when the temperature of the product exceeds or dips below the predetermined range, the label changes color. Using this information, cameras 20 capture the product label in the digital image sent to computing device 90. Then, as previously described, computing device 90 determines the color of the product label and adjusts the price accordingly. Additionally, computing device 90 will update the customer preferences with respect to the product selection and use the updated information to make future product recommendations to the shopper as previously described.

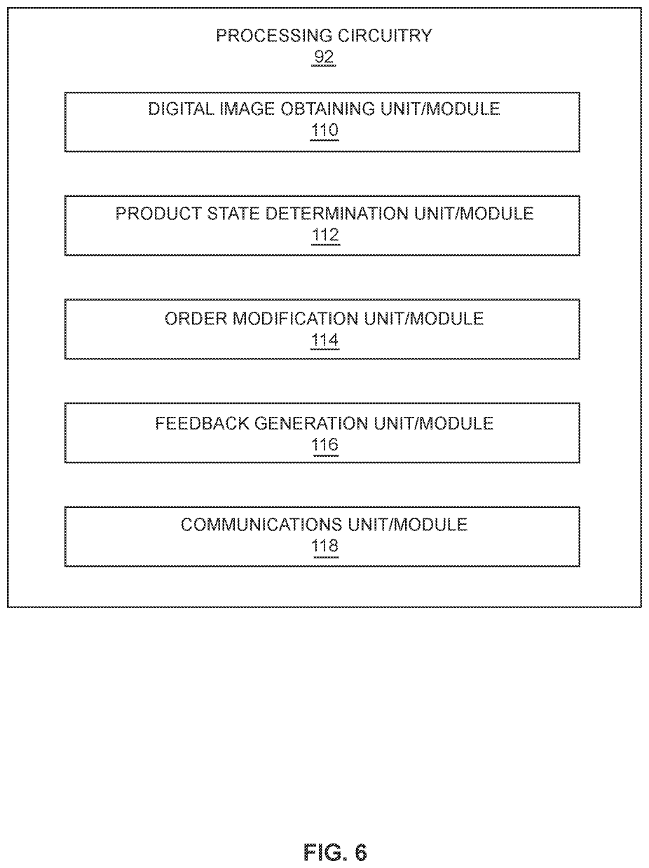

FIG. 5 is a schematic block diagram illustrating some component parts of a computing device 90 configured to provide customers with a frictionless commerce experience according to one embodiment of the present disclosure. Those of ordinary skill in the art should appreciate that the components illustrated in FIG. 5 are merely exemplary, and that computing device 90 may comprise other components not explicitly shown in FIG. 5.

As seen in FIG. 5, computing device 90 comprises processing circuitry 92, communications interface circuitry 94, and memory circuitry 96 storing a control program 98. Processing circuitry 92 comprises one or more microprocessors, hardware circuits, firmware or a combination thereof. In the exemplary embodiments described herein, processing circuitry 92 is configured to determine products that a customer is most likely to be interested in purchasing and recommending those products to a shopper. To accomplish this function, processing circuitry 92, as previously described, is configured to determine one or more physical characteristics and/or attributes of the products the shopper historically selects for purchase, and to track and store that information as personalized preference information. Thereafter, processing circuitry 92 is configured to analyze those preferences and send messages to the shopper recommending products having those “preferred” characteristics and/or attributes.

The communications interface circuitry 94 comprises, in one embodiment, a transceiver circuit and/or interface circuit for communicating with remote devices and systems, such as routers 14, communications system 16, the shopper's personal wireless device 18, cameras 20, and DB 100. For example, using communications interface circuitry 94, computing device 90 can receive, as previously described digital images of the products selected by the shopper from the one or more cameras 20 distributed throughout the retail establishment, data and information from DB 100, including but not limited to copies of the digital images, results of previously performed image analyses performed on the digital images, and the customer preferences. In this regard, the communications interface circuitry 94 according to embodiments of the present disclosure may comprise one or more of a WiFi interface, a cellular radio interface, a BLUETOOTH interface, an Ethernet interface, or other similar interface for communicating over a communication network or a wireless communication link.

Memory circuitry 96 comprises a non-transitory computer readable medium that stores executable program code and data used by the processing circuitry 92 for operation. In this embodiment, the program code and data comprises a control program 98 that, when executed by processing circuitry 92, configures computing device 90 to perform the functions previously described. In some embodiments, control program 98 has access to customer preference information that, as previously described, can be utilized to recommend products for a shopper to purchase. Memory circuitry 96 may include both volatile and non-volatile memory, and may comprise random access memory (RAM), read-only memory (ROM), and electrically erasable programmable ROM (EEPROM) and/or flash memory. Additionally, or alternatively, memory circuitry 96 may comprise discrete memory devices, or be integrated with one or more microprocessors in the processing circuitry 92.

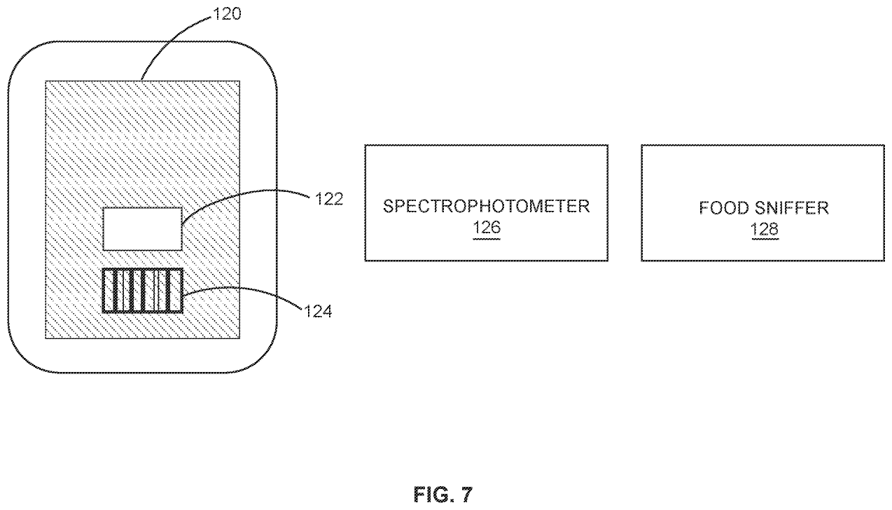

FIG. 6 is a schematic block diagram of a computer program product, such as control program 98, that when executed on processing circuitry 92 configures a computer, such as computing device 90, to recommended products to a shopper according to one embodiment of the present disclosure. As seen in FIG. 6, the computer program product comprises a plurality of units/modules including a digital image obtaining unit/module 110, a product state determination unit/module 112, an order modification unit/module 114, a feedback generation unit/module 116, and a communications interface unit/module 118.

The digital image obtaining unit/module 110 comprises program code that is executed by processing circuitry 92 to obtain the digital images of a shopper and of the products selected by the shopper. Such images may be obtained from DB 100, from one or more of the cameras 20, and/or from one or more other computing devices via network 12.

The product state determination unit/module 112 comprises program code executed by processing circuitry 92 to determine the state of the products selected by the shopper for purchase. For example, as described above, the product state determination unit/module 112 can configure the processing circuitry 92 to determine the stage of ripeness and/or freshness of a product, or any other state of a product based on an analysis of the product's physical characteristics and/or attributes. To this end, the product state determination unit/module 112 can configure the processing circuitry 92 to perform the analysis based on the digital images obtained by the digital image obtaining unit/module 110, and/or analyses performed by other computing devices.

The order modification unit/module 114 comprises program code executed by processing circuitry 92 to modify the pricing of a product selected by the shopper, as previously described, based on the determinations made by the product state determination unit/module 112. By way of example only, the order modification unit/module 114 may control processing circuitry 92 to discount the current price for produce that is deemed to be in a later stage of freshness or ripeness.

The feedback generation unit/module 116 comprises program code executed by processing circuitry 92 to recommend certain products to the shopper for purchase. For example, in one embodiment, the feedback generation unit module 116 generates a message indicating the results of the product state determination unit/module 112 and/or the order modification unit/module 114. These results recommend a product having the same or similar physical characteristics and/or attributes as the products historically selected for purchase by the shopper. The results can also indicate a change in price for the recommended product. So generated, the feedback generation unit module 116 sends the message to the shopper's personal device (e.g., wireless device 18) for display to the shopper.

The communications interface unit/module 118 comprises program code executed by processing circuitry 92 to facilitate communicating data and information with one or more remote devices via one or more communications networks. Such devices include, but are not limited to, routers 14, communications system 16, the shopper's personal wireless device 18, cameras 20, and DB 100. As described above, such data and information includes, but is not limited to, the digital images obtained by cameras 20, customer preference information tracked and stored in DB 100, the results of digital image analyses performed on the digital images obtained by cameras 20, and the messages generated by the feedback generation unit/module 116 for transmission to the shopper's personal wireless device 18.

The present embodiments may, of course, be carried out in other ways than those specifically set forth herein without departing from essential characteristics of the invention. For example, the embodiments previously described utilize digital imagery captured by one or more cameras 20 positioned throughout a retail establishment to determine the state of a product purchased by a shopper. However, those of ordinary skill in the art will readily appreciate that this is merely for illustrative purposes. In one embodiment, system 10 may also capture and utilize information and data captured by other devices in addition to, or in lieu of, cameras 20. As seen in FIG. 7, such devices include, but are not limited to, temperature sensors 120 (e.g., temperature sensitive labels including a printed expiration or use-by date 122 and SKU 124) for indicating the temperature of a product, spectrophotometers 126 for providing data and information relative to the spectral reflectance and/or transmittance of a selected product, and/or various other devices, such as “food sniffer” devices 128 for determining the state of a selected product based on its odor. Devices configured to perform these functions are readily available, and thus, not described in detail here. It is enough to understand, however, that the information captured or indicated by these devices is communicated to computing device 90 and/or DB 100 via network 12 (or to some other computing device connected to network 12) so that computing device 90 can determine a customer's personal preferences when selecting a product for purchase and for using that information to subsequently recommend such products to a shopper.

Therefore, the present embodiments are to be considered in all respects as illustrative and not restrictive, and all changes coming within the meaning and equivalency range of the appended claims are intended to be embraced therein.

What is claimed is:

1. A method of frictionless shopping in a retail store, the method comprising:
obtaining one or more digital images of a product selected for purchase for a customer order;
determining a state of the product based on a digital image analysis performed on the one or more digital images;
generating feedback based on the state of the product and one or more predefined customer preferences for the state of the product; and
transmitting a message comprising the generated feedback to a shopper.

2. The method of claim 1 wherein determining the state of the product based on the digital image analysis comprises determining a ripeness stage for the product based on the digital image analysis.

3. The method of claim 2 wherein determining the ripeness stage of the product comprises:
determining one or more physical attributes of the product based on the digital image analysis;
comparing the one or more physical attributes to information representing one or more colors of the product; and
determining the ripeness stage of the product to correspond to one of the one or more colors based on a result of the comparison.

4. The method of claim 3 wherein the generated feedback indicates replacing the product selected for purchase with another of the same product based on the ripeness stage.

5. The method of claim 1 wherein determining the state of the product based on the digital image analysis comprises determining a freshness of the product.

6. The method of claim 5 wherein the generated feedback indicates replacing the product selected for purchase with another of the same product based on the determined freshness of the product.

7. The method of claim 5 wherein determining the freshness of the product comprises:
determining a freshness date associated with the product from the digital image analysis;
comparing the freshness date to information representing one or more life cycle stages for the product; and
determining the freshness of the product based on the comparison.

8. The method of claim 7 wherein the freshness date is determined based on one or more of:
an expiration date and/or a use-by date indicated on the product;
a temperature-sensitive indicator on the product; and
a position of the product in a display area.

9. The method of claim 1 further comprising:
modifying a sales price of the product based on the state of the product and the one or more predefined customer preferences for the state of the product; and
generating the feedback to indicate the modified sales price.

10. The method of claim 1 further comprising updating one or more predefined customer preferences based on the state of the product purchased by the shopper.

11. A computer device for frictionless shopping in a retail store, the computing device comprising:
communications circuitry configured to communicate data with one or more remote devices via a communications network; and
processing circuitry operatively connected to the communications circuitry and configured to:
obtain one or more digital images of a product selected for purchase for a customer order;
determine a state of the product based on a digital image analysis performed on the one or more digital images;
generate feedback based on the state of the product and one or more predefined customer preferences for the state of the product; and
transmit a message comprising the generated feedback to a shopper.

12. The computing device of claim 11 wherein to determine the state of the product based on the digital image analysis, the processing circuitry is configured to determine a ripeness stage for the product based on the digital image analysis.

13. The computing device of claim 12 wherein the generated feedback indicates replacing the product selected for purchase with another of the same product based on the determined ripeness stage.

14. The computing device of claim 11 wherein to determine the state of the product based on the digital image analysis, the processing circuitry is configured to determine a freshness of the product based on the digital image analysis.

15. The computing device of claim 14 wherein the generated feedback indicates replacing the product selected for purchase with another of the same product based on the determined freshness of the product.

16. The computing device of claim 14 wherein the processing circuitry is configured to determine the freshness of the product based on one or more of:
an expiration and/or use-by date indicated on the product;
a temperature-sensitive indicator on the product; and
a position of the product in a display area.

17. The computing device of claim 11 wherein the processing circuitry is further configured to:
modify a sales price of the product based on the state of the product and the one or more predefined customer preferences for the state of the product; and
generate the feedback to indicate the modified sales price.

18. The computing device of claim 11 wherein the processing circuitry is further configured to update the one or more predefined customer preferences based on the state of the product purchased by the shopper.

19. The computing device of claim 10 wherein the processing circuitry is further configured to augment the customer order based on the state of the product and the one or more predefined customer preferences for the state of the product.

20. A non-transitory computer readable medium comprising a control program stored thereon, the control program comprising instructions that, when executed by processing circuitry of a computing device, causes the computing device to:
obtain one or more digital images of a product selected for purchase for a customer order;
determine a state of the product based on a digital image analysis performed on the one or more digital images;
generate feedback based on the state of the product and one or more predefined customer preferences for the state of the product; and
transmit a message comprising the generated feedback to a shopper.
